(19) United States
(12) Patent Application Publication
(10) Pub. No.: US 2010/0108947 A1
(43) Pub. Date: May 6, 2010

(54) RESIN COMPOSITION, RESIN MOLDED ARTICLE, AND GENERATION METHOD OF RESIN COMPOSITION

(75) Inventors: Shuji Takahashi, Shizuoka (JP); Yunosuke Fukami, Shizuoka (JP); Hiroaki Nagashima, Shizuoka (JP); Hisashige Uebayashi, Shizuoka (JP)

Correspondence Address: DARBY & DARBY P.C., P.O. BOX 770, Church Street Station, New York, NY, 10008-0770, US

(73) Assignee: Suzuki Motor Corporation, Hamamatsu-shi (JP)

(21) Appl. No.: 12/609,547

(22) Filed: Oct. 30, 2009

(30) Foreign Application Priority Data
Oct. 31, 2008 (JP) 2008-281832

(51) Int. Cl. C09K 11/64

(52) U.S. Cl. 252/301.36

(57) ABSTRACT

A luminous material such as an aluminum luminous material of which particle size is 1 μm to 7 μm is added for 1.8 weight parts to 4.4 weight parts relative to 100 weight parts of a resin material such as, for example, an AES resin containing a copolymer. A molding is performed by using a resin composition generated as stated above, and thereby, a resin molded article having luminosity, a suppression effect of interference of scattered light, and associated physical properties can be obtained.

### CROSS-REFERENCE TO RELATED APPLICATIONS

This application is based upon and claims the benefit of priority of the prior Japanese Patent Application No. 2008-281832, filed on Oct. 31, 2008, the entire contents of which are incorporated herein by reference.

### BACKGROUND OF THE INVENTION

1. Field of the Invention

The present invention relates to a resin composition, a resin molded article, and a generation method of the resin composition, and in particular, to an art to obtain a resin molded article in metallic tone by adding an aluminum luminous material and so on to a resin as a base material.

2. Description of the Related Art

For example, user's needs for automobile interior become diversified, and decoration such as a metallic tone, a wood grain tone, or a fabric tone is performed for interior resin components in an automotive industry. There is a resin decorative component in silver metallic tone with luminosity as one of components having especially high market needs among these resin decorative components as stated above.

Conventionally, it is often the case that many of the resin decorative components in silver metallic tone are decorated by painting so as to obtain enough luminosity. However, there have been problems that volatile organic compounds (hereinafter, referred to as VOC) having a possibility of affecting on environment as it is contained in paints used at a painting process, and that the number of working processes also increases.

Accordingly, the painting process is recently omitted by performing the molding by using a colored resin material in which a coloring material and a luminous material are kneaded in advance. The non-painting of the resin decorative components as stated above is very effective because quantity consumed of paint is reduced, emission or generation of VOC is lowered, and further, recycling ability of resin components is improved because of energy saving owing to an abolishment of the painting process or it is not necessary to remove a paint film.

[Patent Document 1] Japanese Patent Publication No. 4120701

[Patent Document 2] Japanese Patent Application Laid-open No. 2007-83434

[Patent Document 3] Japanese Patent Application Laid-open No. 2008-49652

The non-painting of the resin decorative component is generally used centering on so-called a solid color such as white and black. However, luminosity and appearance quality are in a tradeoff relationship in the non-painting of the colored resin material in sliver metallic tone, namely, there is a relationship in which appearance defects such as a weld line and sink are easy to stand out in the appearance if the luminosity is tried to be enhanced, and the luminosity is reduced if the appearance defects are tried to be suppressed. Accordingly, there has been a difficult point in compatibility of the luminosity and the appearance quality which satisfies the market needs and has high commercial value, and it cannot be said that there is a lot of opportunities to be used generally.

As an art to dissolve the appearance defects in the above-stated problem, it is proposed that shapes and so on of a mold and a resin molded article are improved (refer to Patent Documents 1 to 3).

However, the luminosity and so on with high commercial value which satisfies the market needs cannot be obtained if the luminous material is blindly added though there is the art dissolving the appearance defects as stated above.

More specifically, an aluminum luminous material (pigment) is generally added to a resin (for example, an AES resin and so on) as a base material in a colored resin material to exhibit the silver metallic tone. In this case, the smaller an average particle size of the aluminum luminous material is, the more the luminosity increases and the higher a quality image becomes. Namely, the luminosity with high commercial value satisfying the market needs can be obtained, but the appearance defects are easy to occur. On the other hand, if the average particle size of the aluminum luminous material is made large, the appearance defects do not stand out, but the luminosity is damaged, and the luminosity with high commercial value satisfying the market needs is difficult to be obtained.

Besides, if a content rate of the luminous material is made high, the luminosity becomes high, but material physical properties decrease and there is a case when compound becomes difficult if the luminous material is contained too much.

Further, there is a suppression of interference of scattered light as an element of the commercial value satisfying the market needs in the resin decorative components such as in silver metallic tone. The interference of scattered light results from refractive indexes of substances contained in the resin as the base material, and a state in which lights reflected from plural substances having different refractive indexes interfere is called as the interference of scattered light. When there is a lot of interference, a color tone becomes different depending on viewing angles, and the quality image is not good. The interference of scattered light also changes drastically depending on the particle size and the content rate of the luminous material.

Caused by complicated various circumstances as for content of the luminous material as stated above, it has been difficult to simultaneously satisfy the luminosity with high commercial value satisfying the market needs, the suppression effect of the interference of scattered light, enough physical properties satisfying the market needs, further, a requirement in cost, and so on, in the conventional resin decorative component. Incidentally, the physical properties mean a tensile strength, an impact strength, and so on.

### SUMMARY OF THE INVENTION

The present invention is made with considering the above-stated actual circumstances, and an object thereof is to provide a resin composition and so on capable of simultaneously satisfying fine luminosity enough satisfying market needs, a suppression effect of interference of scattered light, enough physical properties, and further, a requirement in cost by optimizing a kind, and a content rate of a luminous material contained in a resin material to be a base material.

A resin composition of the present invention includes: a resin material for 100 weight parts containing one or plural kinds of copolymers; and a luminous material of which particle size is 1 μm to 7 μm added to the resin material for 1.8 weight parts to 4.4 weight parts.

According to another aspect of the resin composition of the present invention, an average particle size of the luminous material is 5 μm.

According to another aspect of the resin composition of the present invention, the resin material containing the copolymer is a styrene based copolymer.

According to another aspect of the resin composition of the present invention, the resin material containing the copolymer is an AES resin, an ABS resin, or an ASA resin.

According to another aspect of the resin composition of the present invention, the luminous material is an aluminum luminous material.

According to another aspect of the resin composition of the present invention, the resin composition is used to generate a resin molded article in silver metallic tone.

Besides, another resin composition of the present invention includes: a resin material for 100 weight parts containing two or more kinds of substances of which refractive indexes are different; and a luminous material of which particle size is 1 μm to 7 μm added to the resin material for 1.8 weight parts to 4.4 weight parts.

According to another aspect of the resin composition of the present invention, an average particle size of the luminous material is 5 μm.

According to another aspect of the resin composition of the present invention, the luminous material is an aluminum luminous material.

According to another aspect of the resin composition of the present invention, the resin composition is used to generate a resin molded article in silver metallic tone.

Besides, a resin molded article of the present invention is a resin molded article molded from the above-stated resin composition.

Besides, a generation method of a resin composition of the present invention includes: adding a luminous material of which particle size is 1 μm to 7 μm for 1.8 weight parts to 4.4 weight parts relative to 100 weight parts of a resin material containing one or plural kinds of copolymers.

Further, another generation method of a resin composition of the present invention includes: adding a luminous material of which particle size is 1 μm to 7 μm for 1.8 weight parts to 4.4 weight parts relative to 100 weight parts of a resin material containing two or more kinds of substances of which refractive indexes are different.

### BRIEF DESCRIPTION OF THE DRAWINGS

FIG. 1 is a view to explain a range of a particle size and a content rate of a luminous material in a resin composition according to the present invention;

FIG. 2 is a view schematically illustrating the resin composition according to the present invention;

FIG. 3 is a view to explain a principle of measurement of a multi-angle color measurement method;

FIG. 4 is a view illustrating a relationship between a particle size and an FF value of an aluminum luminous material which is added to a resin to be a base material;

FIG. 5 is a view representing a result in which a difference between the particle size of the aluminum luminous material added to the resin to be the base material and a value of “a*” indicating a color shade is verified;

FIG. 6 is a view illustrating a relationship between the particle size of the aluminum luminous material added to the resin to be the base material and a tensile strength;

FIG. 7 is a view illustrating a relationship between the particle size of the aluminum luminous material added to the resin to be the base material and a Charpy impact strength;

FIG. 8 is a view illustrating a relationship between a content rate of the aluminum luminous material added to the resin to be the base material and an FF value;

FIG. 9 is a view illustrating a relationship between the content rate of the aluminum luminous material added to the resin to be the base material and a “value” indicating the color shade;

FIG. 10 is a view illustrating a relationship between the content rate of the aluminum luminous material added to the resin to be the base material and the tensile strength;

FIG. 11 is a view illustrating a relationship between the content rate of the aluminum luminous material added to the resin to be the base material and the Charpy impact strength;

FIG. 12 is a photograph of a resin molded article according to an example 1 of the present invention;

FIG. 13 is a photograph of a molded article to which silver metallic painting is performed; and

FIG. 14 is a photograph of a molded article which does not contain the aluminum luminous material.

### DETAILED DESCRIPTION OF THE PREFERRED EMBODIMENTS

Hereinafter, embodiments of the present invention are described.

The present invention relates to a resin composition in which a luminous material of which particle size is 1 μm to 7 μm is added for 1.8 weight parts to 4.4 weight parts relative to 100 weight parts of a resin material containing one or plural kinds of copolymers, or a resin composition in which the luminous material of which particle size is 1 μm to 7 μm is added for 1.8 weight parts to 4.4 weight parts relative to 100 weight parts of the resin material containing two or more kinds of substances of which refractive indexes are different, a resin molded article, and so on.

In the present invention, a resin composition capable of obtaining fine luminosity, a suppression effect of interference of scattered light, and physical properties in a resin molded article can be generated by adding a luminous material to a resin material as a base material, as stated above.

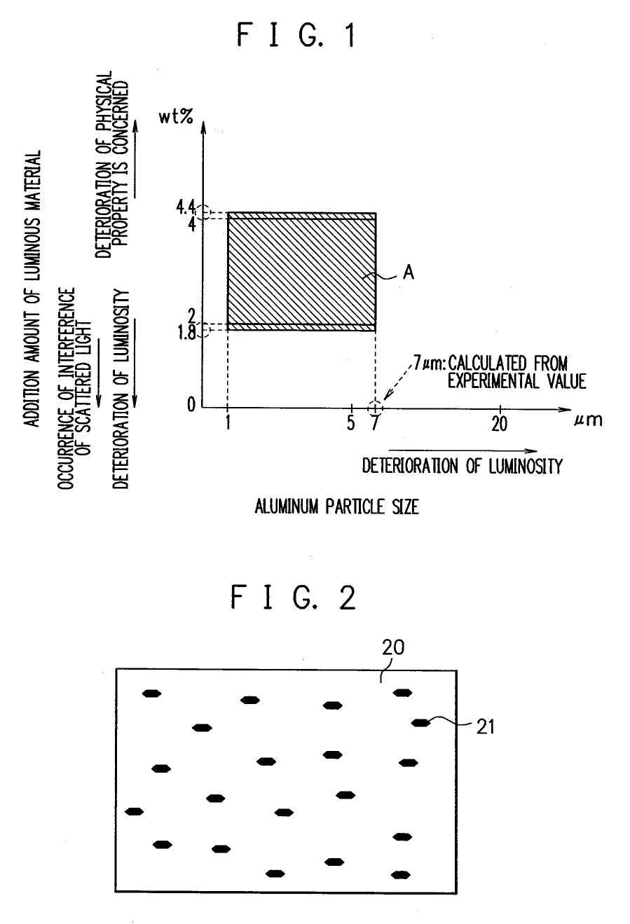

Namely, in the present invention, the luminous material is contained (added) in the resin material as a range “A” illustrated in FIG. 1. Specifically, a particle size (average particle size) of the luminous material is set to be 1 μm to 7 μm, and a content rate relative to the resin material is set to be 1.8% by weight to 4.4% by weight. The above-stated numerical values are found out as a result of hard investigation considering various requests relating to a deterioration of luminosity, deteriorations of interference of scattered light and physical properties, and so on. Details of the numerical values are described in the following examples.

### <Resin Material as Base Material>

In an embodiment of the present invention, acrylonitrile-ethylene propylene rubber-styrene copolymer (hereinafter, referred to as AES resin: manufactured by Techno Polymer Co., Ltd.) is used for a resin material as a base material. Incidentally, the resin material as the base material according to the present invention is not limited to the AES resin, but acrylonitrile-butadiene-styrene copolymer (ABS resin), acrylonitrile-methyl acrylate-styrene copolymer (ASA resin), and so on being styrene based copolymers may be used. A resin material in which the other kind of resin is further mixed to the styrene based copolymers as stated above may be used, and for example, a resin alloy material (a polycarbonate resin (PC) and the ABS resin are mixed) and so on can be cited as concrete examples as stated above.

The AES resin according to the present embodiment is a styrene based ternary copolymer. In the copolymer, each monomer being a component has unique refractive index. The property as stated above is common to the above-stated ABS resin, ASA resin, resin alloy material, and so on. In the resin material constituted by copolymerizing the plural monomers, in other words, containing plural substances having different refractive indexes, there is a possibility that an interference phenomenon of scattered light may occur in a resin molded article after a molding. One of the problems to be solved by the present invention is to improve the suppression effect of the scattered light, and therefore, substances in which the interference phenomenon of scattered light is easy to occur are selected as main targets relating to the resin material as the base material.

The AES resin according to the present embodiment is opaque and milk white before it is colored, and it is possible to be colored by using a coloring agent in accordance with a resin molded article to be molded. Incidentally, the present invention is typically intended to mold a resin decorative component in silver metallic tone, and the coloring is not necessary in this case, but the present invention can be suitably applied to the resin decorative component in gold metallic tone, so-called a gun metallic tone. In this case, the coloring is performed by appropriately mixing an inorganic pigment, an organic pigment, or dyes in a molten state.

### <Luminous Material>

In the present embodiment, an aluminum luminous material (aluminum paste: manufactured by Toyo Aluminum Co., Ltd.) is used as the luminous material added to the resin material as the base material to exhibit the metallic tone. A particle size (average particle size) of the aluminum luminous material is set to be 1 μm to 7 μm as stated above. Incidentally, mica powder and so on can be used as the luminous material to exhibit the metallic tone.

### <Resin Composition>

FIG. 2 is a view schematically illustrating a state in which the aluminum luminous material as stated above is added to the AES resin, namely, a substance contained in the resin composition according to the present embodiment. As illustrated in FIG. 2, the resin composition is in a state that an aluminum luminous material 21 is contained in a dotted state in an AES resin 20. The AES resin 20 is constituted by graft polymerizing (copolymer) an AS resin phase and an ethylene propylene rubber phase.

A molding such as an injection molding is performed by using the resin composition as stated above, and thereby, a resin molded article being the resin decorative component in silver metallic tone can be molded, and a resin composition satisfying enough luminosity satisfying market needs, a suppression effect of interference of scattered light, physical properties, and so on can be generated by adding the luminous material of which particle size is 1 μm to 7 μm for 1.8 weight parts to 4.4 weight parts relative to 100 weight parts of the resin material as stated above.

### Example 1

Next, a resin composition is generated by adding 2 weight parts of the aluminum luminous material of which particle size is 5 μm relative to 100 weight parts of the AES resin, and a resin molded article in silver metallic tone molded from the resin composition is cited as an example of the present invention to describe the luminosity, the suppression of interference of scattered light, and the physical properties thereof together with a comparative example.

### <FF Property (Flip-Flop Property)>

At first, an FF property (flip-flop property) of the resin molded article according to the example is described.

The FF property is a phenomenon in which brightness, a color tone are looked to be changed depending on viewing angles, and it becomes an index capable of evaluating the luminosity of a resin molded article. The metallic tone basically has a finishing surface with a strong specular reflection component, and therefore, it becomes possible to evaluate the luminosity exhibited from the metallic tone by comparing brightness of respective reflection components of light sources having different angles.

In the present example, an index evaluating the FF property (hereinafter, called as an FF value) is asked by using the next expression (1) to evaluate the luminosity.

FF value=Brightness at highlight time)(25°/Brightness at shade time)(75°) (1)

Respective angles of 25°, 75° in the expression (1) represent angles when a measurement sample (resin molded article) is put on a plane surface, and a vertical direction thereof is set as a reference)(0°). As stated above, the metallic tone basically has the finishing surface with the strong specular reflection component. Accordingly, the specular reflection component relative to the light source in the highlight direction)(25°) is strong, and a diffuse reflection component is weak in the shade direction (75°). It is therefore possible to evaluate highness of the luminosity by the FF value which is a ratio of the brightness between the highlight time and the shade time. It can be evaluated that the luminosity is high as the FF value is high, in this evaluation.

As a measuring method of the brightness of the reflection component to ask the FF value, so-called a multi-angle color measurement method is used, and the brightness at the highlight time)(25°) and the brightness at the shade time)(75°) in the expression (1) are asked.

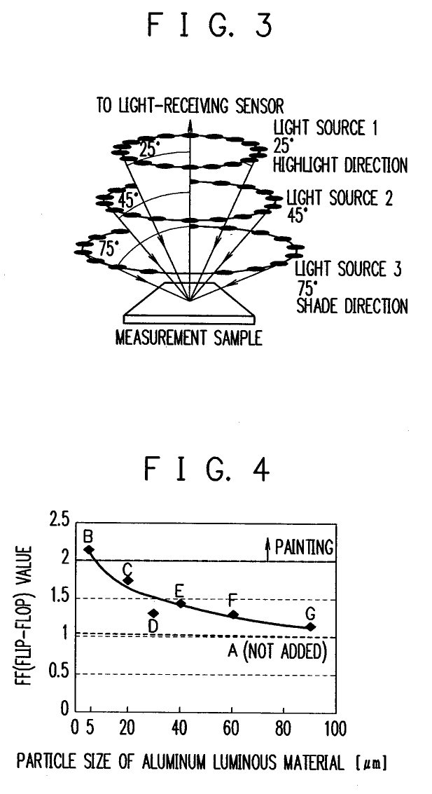

FIG. 3 is a view to explain a principle of measurement of the multi-angle color measurement method. As illustrated in FIG. 3, the multi-angle color measurement method is performed by disposing three light sources (1 to 3) each having different disposing angles, and by measuring the brightness of the reflection components of a measurement sample relative to the light sources by a light-receiving sensor disposed in the vertical direction of the measurement sample, in this example. In FIG. 3, the disposing angles of the light sources 1 to 3 are 25°, 45°, 75° respectively while setting the vertical direction of the measurement sample as a reference. Incidentally, a spectrophotometric colorimeter (CM-512 m3) manufactured by Konica Minolta is used as a measuring equipment to perform the measurement.

As a result of asking the FF value, a numerical value of 2.14 can be obtained as the FF value of the resin molded article according to the present example. In a molded article to which silver metallic painting is performed as an example of comparison, the FF value of 2.0 or more is generally required for an automobile interior. Accordingly, the resin molded article according to the present example is able to obtain the result having the luminosity equal to or more than the silver metallic painting.

Here, a result comparing samples of which content rate (addition amount) of the aluminum luminous material is set constant and particle sizes are different, and a sample in which the aluminum luminous material is not added is described to explain the high luminosity of the resin molded article according to the present example in more detail. The samples being the comparison targets are as illustrated in the following table 1.

TABLE 1
Test samples in which particle sizes of
aluminum luminous material are changed

Aluminum luminous material

| | Average particle | Addition amount |
|---|---|---|
| | size | (constant at 2.0 wt %) |
| Sample A | — | — |
| Sample B | 5 μm | 2.0 wt % |
| Sample C | 20 μm | 2.0 wt % |
| Sample D | 30 μm | 2.0 wt % |
| Sample E | 40 μm | 2.0 wt % |
| Sample F | 60 μm | 2.0 wt % |
| Sample G | 90 μm | 2.0 wt % |

In Table 1, the sample A is a resin molded article in which the aluminum luminous material is not added. The sample B is a resin molded article according to the present example, and the aluminum luminous material of which average particle size is 5 μm is added for 2.0% by weight. The samples C to G are resin molded articles in which the aluminum luminous materials of which average particles sizes are 20 μm, 30 μm, 40 μm, 60 μm, 90 μm are respectively added for 2.0% by weight. The results of these FF values are illustrated in FIG. 4. Incidentally, this comparison has meanings to judge a range of the average particle size to obtain the high luminosity, the suppression effect of the interference of scattered light, and enough physical properties when the content rate of the aluminum luminous material is set to be equal, in addition to describe how high the luminosity of the sample B is.

FIG. 4 is a view illustrating a relationship between the average particle size and the FF value of the aluminum luminous material. In FIG. 4, the FF value of the sample A is approximately 1.0 (1.08 to be precise) as represented by “A (not added)”. Besides, the FF values of the samples B to G are values corresponding to plots of B to G in the drawing.

As illustrated in FIG. 4, when the aluminum luminous material is added (samples B to G), the FF values are higher compared to the sample A in which the aluminum luminous material is not added. Namely, it results in that the luminosity is high, but the FF value decreases as the average particle size of the aluminum luminous material becomes large. Further, the sample of which FF value is 2.0 or more, namely, capable of obtaining the luminosity equal to or more than the case when it is painted is only the sample B according to the example of the present invention.

It turns out from the result as stated above that the luminosity changes depending on the particle size, and a range of the particle size capable of obtaining the high luminosity satisfying the market needs is determined. Namely, it is adequate to set the particle size at least at 20 μm or smaller to obtain the luminosity equal to or more than the painting, and further, the FF value is necessary to be 2.0 or more. The present applicant asked an approximated curve illustrated in FIG. 4 from a test result of the samples of which particle sizes are different to define the range more rigidly. As a result, it turns out that the average particle size of the aluminum luminous material capable of obtaining the luminosity equal to or more than the painting is suitable to be set at 7 μm or less.

The optimal particle size of the aluminum luminous material added to the AES resin is turned out by the evaluation of the FF value as stated above. Namely, in the present invention, the optimal particle size of the luminous material added to the resin material as the base material is turned out to be 1 μm to 7 μm according to this result. Incidentally, a lower limit is set to be 1 μm because an actual particle size (easiness of manufacturing and so on) of the aluminum luminous material is considered.

### <Suppression Effect of Interference of Scattered Light>

Next, a suppression effect of interference of scattered light of the resin molded article according to the present example is described.

The interference of scattered light means that lights reflected from plural substances having different refractive indexes interfere, and a color tone looks different depending to viewing angles when a lot of interference occurs.

The resin molded article according to the present example can be evaluated that the color tone is the same independent from the angles as a result of a visual evaluation. The samples C to G are also performed the visual evaluation for a comparison purpose, and these samples are verified that different color tones are exhibited depending on the angles. This visual evaluation result is corresponded to the FF values asked as stated above, and the result is illustrated in the following table 2.

TABLE 2
Evaluation result of Interference of
Scattered Light (visual observation)

| | Interference | | |
|---|---|---|---|
| | occurrence visual | FF (flip | |
| | evaluation | flop) value | Aluminum |
| | ∘: suppress, | ∘: 2.0 or more, | luminous |
| | x: occur | x: less than 2.0 | material |
| Sample A | — | x | not added |
| Sample B | ∘ | ∘ | 5 μm, 2.0 wt % |
| Sample C | x | x | 20 μm, 2.0 wt % |
| Sample D | x | x | 30 μm, 2.0 wt % |
| Sample E | x | x | 40 μm, 2.0 wt % |
| Sample F | x | x | 60 μm, 2.0 wt % |
| Sample G | x | x | 90 μm, 2.0 wt % |

As illustrated in table 2, it can be judged that a lot of interference of scattered light occurs in all of the samples C to G of which FF values are smaller than 2.0 from the visual evaluation result. It turns out that the FF value is necessary to be 2.0 or more to fully suppress the scattered light from the result, and the optimal particle size of the luminous material added to the resin material as the base material is determined to be 1 μm to 7 μm as same as the above-stated evaluation of the FF value.

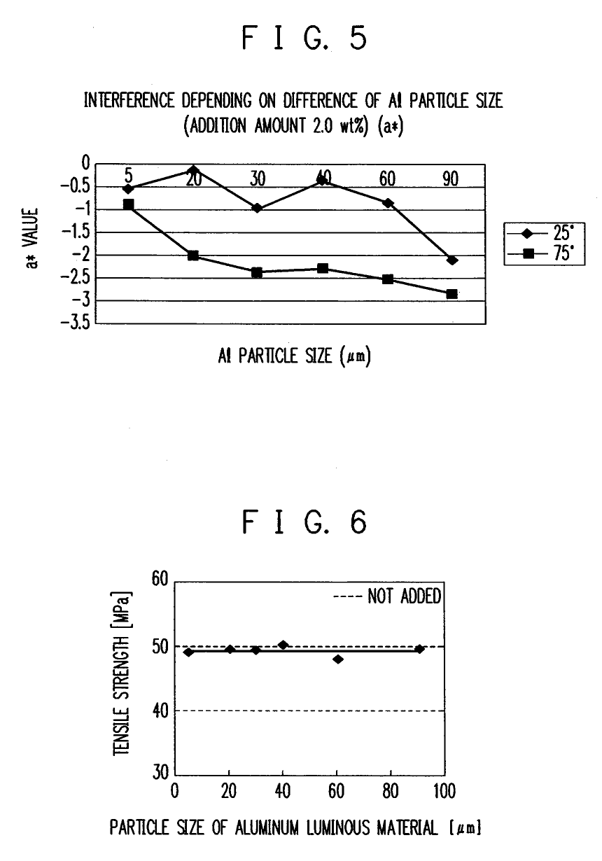

Further, the present applicant extracts color shades of reflection components of respective light sources of different angles for the samples B to G, and they are evaluated by comparing them to investigate whether the interference of scattered light is suppressed or not more rigidly. As the color shade, “a (redness, greenness)” is used, and the suppression effect is verified by evaluating a difference of “a*” value. The verification result is illustrated in FIG. 5. Incidentally, it can be evaluated that the change of color tone in accordance with the angle does not exist, namely, the interference between the redness and the greenness is small as the difference of the “a*” values is small. Besides, the different angles are the highlight (25°) and the shade (75°), and the spectrophotometric colorimeter (CM-512 m3) manufactured by Konica Minolta is used for the measurement as same as the above.

In FIG. 5, a horizontal axis represents the particle size of the aluminum luminous material, and a vertical axis represents the “value”. As illustrated in FIG. 5, a difference between the “a* value” at highlight time and the “value” at shade time is extremely small as for the sample of which particle size is 5 μm (the sample B according to the present example) compared to the other particle sizes (samples C to G). It turns out that an aluminum pigment of 5 μm is optimal to fully suppress the interference of scattered light from this result, and it can be verified that the optimal particle size of the luminous material added to the resin material as the base material is 1 μm to 7 μm, as same as the above-stated evaluation of the FF value.

### <Material Physical Properties>

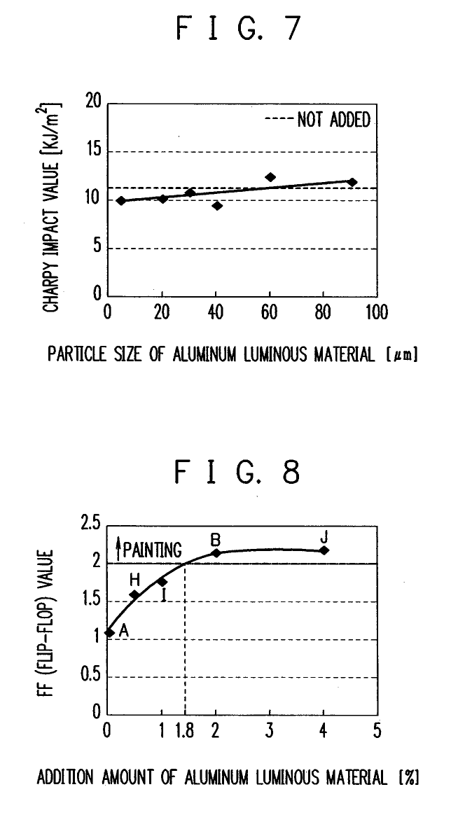

Next, material physical properties of the resin molded article according to the present example are described. Here, an influence affected by the particle sizes of the aluminum luminous material on the material physical properties is verified. Concrete physical properties are a tensile strength and a Charpy impact strength (room temperature), and a physical property test is performed for the above-stated samples A to G. A test result is illustrated in the following table 3, and plotted diagrams are represented in FIG. 6 and FIG. 7 so as to make it easy to compare the test results.

TABLE 3
Physical property test result of test samples in which particle
sizes of the aluminum luminous material are changed

| | Sample | Sample | Sample | Sample | Sample | Sample | Sample |
|---|---|---|---|---|---|---|---|
| | A | B | C | D | E | F | G |
| FF value | 1.08 | 2.14 | 1.75 | 1.31 | 1.45 | 1.31 | 1.17 |
| Tensile | 49.6 | 49.2 | 49.6 | 49.6 | 50.1 | 48.1 | 49.5 |
| strength | | | | | | | |
| [MPa] | | | | | | | |
| Charpy impact | 11.5 | 10 | 10.1 | 10.7 | 9.5 | 12.3 | 12 |
| strength (room | | | | | | | |
| temperature) | | | | | | | |
| [kJ/m²] | | | | | | | |
| Aluminum | not | 5 | 20 | 30 | 40 | 60 | 90 |
| particle | added | | | | | | |
| size [μm] | | | | | | | |

In FIG. 6 and FIG. 7, horizontal axes represent the particle sizes of the aluminum luminous material, and vertical axes represent measurement results. As illustrated in FIG. 6, it can be judged that the influence affected by the change of the particle size of the aluminum luminous material on the tensile strength is small, and physical property values are approximately equal independent from the particle size. On the other hand, as illustrated in FIG. 7, the Charpy impact strength varies in accordance with the particle size, and it results in that the larger the particle size is, the higher the impact strength becomes. However, it is also verified that the variation is within a tolerance range (within ±2%) of the sample A to which the luminous material is not added even when the particle size is small, and therefore, it is a range with no problem as for the physical property.

As stated above, in the resin molded article in silver metallic tone (sample B) according to the example 1 of the present invention molded from the resin composition generated by adding the aluminum luminous material of which particle size is 5 μm for 2 weight parts relative to 100 weight parts of the AES resin, the FF value is 2.0 or more which is the value equal to or more than the painting, and the fine luminosity enough satisfying the market needs, and the suppression effect of the interference of scattered light are held. Further, the result satisfying the market needs can also be obtained as for the physical properties.

Further, the optimal particle size of the luminous material added to the resin material as the base material can be selected to be 1 μm to 7 μm as a result performing the verification between the comparative examples.

### Example 2

In an example 2, a resin composition is generated by adding an aluminum luminous material of which particle size is 5 μm for 4 weight parts relative to 100 weight parts of an AES resin, and a resin molded article in silver metallic tone molded from the resin composition is cited as an example of the present invention, and luminosity, suppression of interference of scattered light, and physical properties thereof are described together with comparative examples. Namely, the one in which the particle size of the aluminum luminous material is set to be 5 μm, and a content rate is set to be 4.0% by weight is cited as a sample according to the example, and the sample B according to the example 1, the ones in which the particle sizes of the aluminum luminous materials are set to be 5 μm and the content rates are set to be 0.5% by weight, 1.0% by weight, and the one which does not contain the aluminum luminous material are cited as comparative examples, to describe the present example. The samples being comparison targets are as illustrated in the following table 4.

TABLE 4
Test samples in which addition amounts of
aluminum luminous material are changed

Aluminum luminous material

| | Average particle size | |
|---|---|---|
| | (constant at 5 μm) | Addition amount |
| Sample A | — | — |
| Sample H | 5 μm | 0.5 wt % |
| Sample I | 5 μm | 1.0 wt % |
| Sample B | 5 μm | 2.0 wt % |
| Sample J | 5 μm | 4.0 wt % |

In table 4, the sample A is the resin molded article to which the aluminum luminous material is not added which is also represented in the example 1. The sample B is the resin molded article according to the example 1, and the aluminum luminous material of which average particle size is 5 μm is added to the AES resin for 2.0% by weight. A sample H is the one in which the aluminum luminous material of which average particle size is 5 μm is added to the AES resin for 0.5% by weight, and a sample I is the one in which the aluminum luminous material of which average particle size is 5 μm is added to the AES resin for 1.0% by weight. A sample J is a resin molded article according to the present example, and the aluminum luminous material of which particle size is 5 μm is added to the AES resin for 4.0% by weight.

Incidentally, comparisons between the sample according to the present example and the other samples are to explain how high the luminosity of the sample J is, and at the same time, it has a meaning to judge a range of the content rate to obtain the fine luminosity, the suppression effect of the interference of scattered light, and the enough physical properties when the average particle sizes are set to be the same size (5 μm).

### <FF Property (Flip-Flop Property)>

FIG. 8 is a view illustrating a relationship between the content rate of the aluminum luminous material and the FF value. Incidentally, the evaluation method of the FF property is the same as the above-stated example 1.

In FIG. 8, the FF value of the sample A is approximately 1.0 (1.08 to be precise) as it is illustrated as “A (not added)”. Besides, the FF values of the samples B, H, I, J are values indicated by corresponding plots (B (2.14), H (1.59), I (1.76), J (2.19), respectively).

As illustrated in FIG. 8, the samples of which content rates of the aluminum luminous material are 2.0% by weight or more (samples B, J) result in that the FF values are 2.0 or more, namely, the luminosity equal to or more than a case when it is painted is obtained. On the other hand, the samples of which content rates are 2% by weight or less cannot obtain the FF values of 2.0 or more.

Besides, as illustrated in FIG. 8, a comparison between the FF values of the sample B and the sample J results in a small difference. It turns out from this result that further improvement of the luminosity cannot be expected even if the content rate is increased when the content rate of the aluminum luminous material is 2.0% by weight or more.

The content rate of the aluminum luminous material relative to the AES resin is turned out to be 2.0% by weight or more on a test base considering the results up to now.

Besides, the value of the FF value becomes high as the content rate is made high, but it turns out that there is no substantial difference in the FF value if the content rate is made higher when it is 2.0% by weight or more. On the other hand, when the content rate of the aluminum luminous material exceeds 5% by weight, there are circumstances in which the material physical properties deteriorate drastically or the compound becomes difficult, and therefore, the increase of the content rate also affects on cost. An upper limit of the content rate of the aluminum luminous material is preferable to be 4.0% by weight considering these points.

Further, the present applicant asked an approximated curve based on a test result illustrated in FIG. 8 to ask an optimal range of the content rate of the aluminum luminous material. As a result, it turns out that a lower limit of the content rate capable of obtaining the luminosity equal to or more than a painted one is 1.8% by weight which is a point where the approximated curve intersects with the FF value of 2.0, and it is judged to be optimal that this point is set as a lower limit value of the content rate. This lower limit value is within a range of ±10% of the sample B of which measurement test of the FF value is actually performed. It is therefore adequate to set an upper limit value of the content rate to be ±10% of the sample J of which measurement test of the FF value is actually performed, considering the above-stated point.

In the present invention, the range of the content rate of the aluminum luminous material of which average particle size is 5 μm is judged to be optimal from 1.8% by weight to 4.4% by weight.

### <Suppression Effect of Interference of Scattered Light>

Next, a suppression effect of interference of scattered light of the resin molded article according to the present example is described.

The interference of scattered light means that lights reflected from plural substances of which refractive indexes are different interfere, and there is a case when the color tone looks different depending on the viewing angles when a lot of interference occurs.

As a result of visual evaluation of the resin molded article according to the present example, it can be evaluated that the color tone is the same independent from the angles. The visual evaluations are also performed as for the above-stated samples H, I for a comparison purpose, but it is verified that different colors are exhibited depending on the angles as for these samples. Table 5 in which this visual evaluation result is corresponded to the FF values asked above is illustrated as follows.

TABLE 5
Evaluation result of interference of
scattered light (visual observation)

| | Interference | | |
|---|---|---|---|
| | occurrence visual | FF (flip | |
| | evaluation | flop) value | Aluminum |
| | ∘: suppress, | ∘: 2.0 or more, | luminous |
| | x: occur | x: less than 2.0 | material |
| Sample A | — | x | not added |
| Sample B | ∘ | ∘ | 5 μm, 2.0 wt % |
| Sample H | x | x | 5 μm, 0.5 wt % |
| Sample I | x | x | 5 μm, 1.0 wt % |
| Sample J | ∘ | ∘ | 5 μm, 4.0 wt % |

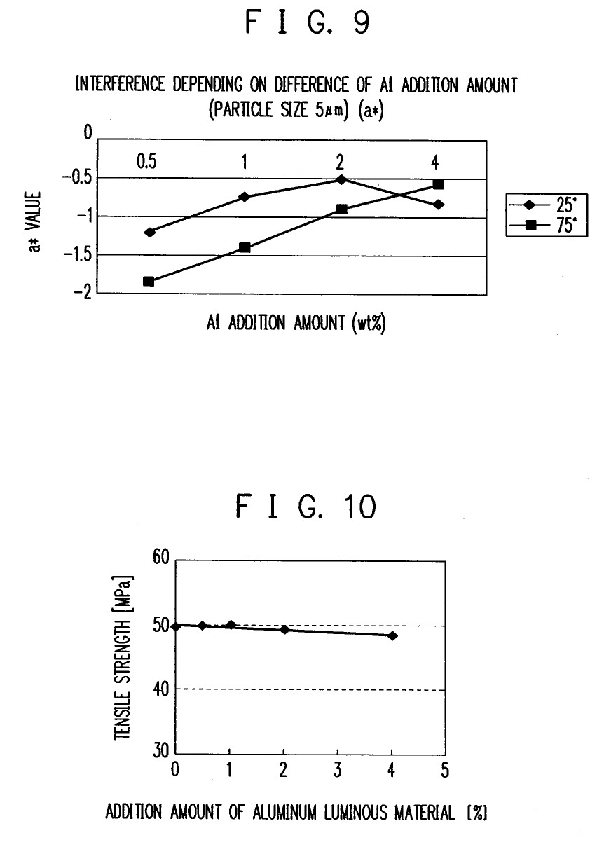

Further, the present applicant extracts color shades of reflection components of respective light sources of different angles for the samples B, H, I, J, and they are evaluated by comparing them to investigate whether the interference of scattered light is suppressed or not more rigidly. As the color shade, “(redness, greenness)” is used, and the suppression effect is verified by evaluating a difference of “a*” value. A verification result is illustrated in FIG. 9. Incidentally, it can be evaluated that the change of color tone in accordance with the angles does not exist as the difference of “a*” values is small, as same as it is described in the example 1. Besides, the different angles are set to be highlight (25°) and shade (75°), and the measurement is performed as same as the example 1.

In FIG. 9, a horizontal axis represents the content rate (addition amount) of the aluminum luminous material, and a vertical axis represents the “a* value”. As illustrated in FIG. 9, it turns out that the difference between the “a* value” at highlight time and the “a* value” at shade time is extremely small during the period when the content rate of the aluminum luminous material is from 2.0% by weight to 4.0% by weight compared to the case when it is less than 2.0% by weight. It turns out from the result that an addition amount of an aluminum pigment is required to be 2.0% by weight or more to fully suppress the interference of scattered light, and it can be verified that an optimal range of the content rate of the aluminum luminous material of which average particle size is 5 μm is from 1.8% by weight to 4.4% by weight.

### <Material Physical Properties>

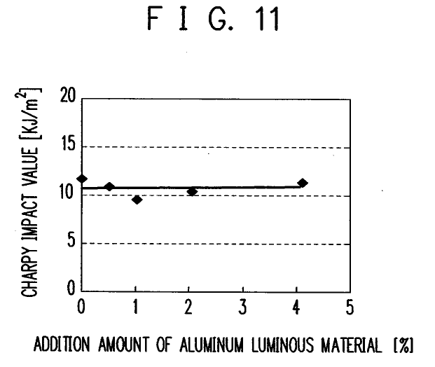

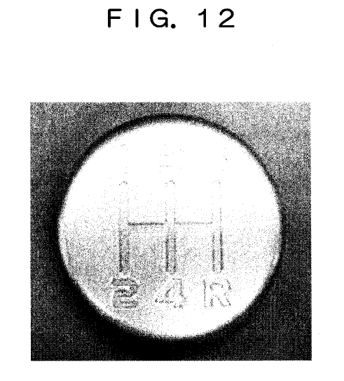

Next, material physical properties of the resin molded article according to the present example are described. Here, an influence affected by the content rate of the aluminum luminous material on the material physical properties is verified. Concrete physical properties are a tensile strength and a Charpy impact strength (room temperature), and a physical property test is performed for the above-stated samples H, I, J. A measurement result is illustrated in the following table 6, and plotted diagrams are represented in FIG. 10 and FIG. 11 so as to make the measurement result easy to compare.

TABLE 6
Physical property test result of test samples in which content
rates of the aluminum luminous material are changed

| | Sample | Sample | Sample | Sample | Sample |
|---|---|---|---|---|---|
| | A | H | I | B | J |
| FF value | 1.08 | 1.59 | 1.76 | 2.14 | 2.19 |
| Tensile | 49.6 | 49.9 | 49.9 | 49.3 | 48.4 |
| strength | | | | | |
| [MPa] | | | | | |
| Charpy impact | 11.5 | 10.8 | 9.6 | 10.4 | 11.2 |
| strength (room | | | | | |
| temperature) | | | | | |
| [kJ/m²] | | | | | |
| Luminous | not | 0.5 | 1.0 | 2.0 | 4.0 |
| material | added | | | | |
| addition | | | | | |
| amount [wt %] | | | | | |

In FIG. 10 and FIG. 11, horizontal axes represent content rates (addition amounts) of the aluminum luminous material, and vertical axes represent measurement results. As illustrated in FIG. 10, it turns out that the tensile strength deteriorates as the content rate of the aluminum luminous material increases. However, a concrete value of the sample J of which content rate is 4.0% by weight is 48.4 Mpa, and it is within a tolerance range (within 5%) of the sample A to which the aluminum luminous material is not added, and it is not a range to be concerned in the physical property. On the other hand, as illustrated in FIG. 11, the Charpy impact strength results in that the physical property value scarcely vary independent from the change of the content rate.

It turns out from a result of the above-stated physical property test that the physical property does not vary in a range to be concerned until the content rate in a test base is 4.0% by weight, and it is necessary to concern the physical property when the content rate exceeds 5% by weight from an inclination of the test result illustrated in FIG. 10. As a result, it can be verified that the physical properties does not change if the content rate is from 1.8% by weight to 4.4% by weight, and this range is the optimal content rate.

As stated above, in the resin molded article in silver metallic tone (sample J) molded by the resin composition generated by adding the aluminum luminous material of which particle size is 5 μm for 4.0 weight parts relative to 100 weight parts of the AES resin according to the example 2 of the present invention, the FF value is 2.0 or more which is the value equal to or more than the painting, and the fine luminosity enough satisfying the market needs, and the suppression effect of the interference of scattered light are held. Further, the result satisfying the market needs can also be obtained as for the physical properties.

Further, the optimal content rate of the aluminum luminous material relative to the AES resin satisfying a requirement in cost in addition to the above-stated luminosity and so on is turned out to be 1.8% by weight to 4.4% by weight as a result of the verification performed between the comparative example.

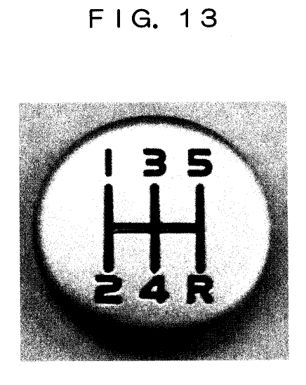

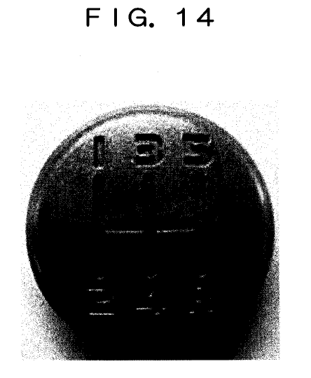

Hereinabove, the embodiments and examples of the present invention are described. The resin molded article molded from the resin composition according to the embodiments of the present invention obtains the result having the fine luminosity enough satisfying the market needs and the suppression effect of the interference of scattered light, and further, satisfying the market needs also in the material physical properties and the requirement in cost, as it is described in the examples. Here, FIG. 12 is a photograph of a resin molded article according to the example 1, FIG. 13 is a photograph of a molded article performing a silver metallic painting, and FIG. 14 is a photograph of a molded article which does not contain the aluminum luminous material. It can be seen that the resin molded article represented in FIG. 12 according to the present invention has the luminosity equal to or more than the painted one by comparing FIG. 12 to FIG. 14.

Incidentally, the present invention can be applied to various components in which the luminosity equal to or more than the metallic painting is required. Besides, it can correspond to various metallic tones without being limited to the silver metallic tone described in the embodiments and examples of the present invention. Further, it is described on an assumption of the automobile interior component in the embodiments and examples of the present invention, but it is applicable for components in a motorcycle, resin decorative components in wide fields such as household electric apparatuses, AV equipments, OA equipments, cosmetics, general merchandises, and office supplies.

According to the present invention, it is possible to provide a resin composition capable of simultaneously satisfying fine luminosity enough satisfying market needs, a suppression effect of interference of scattered light, physical properties, and a requirement in cost, in a resin molded article.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A resin composition, comprising:
a resin material for 100 weight parts containing one or plural kinds of copolymers or containing two or more kinds of substances of which refractive indexes are different; and
a luminous material of which particle size is 1 lam to 7 μm added to said resin material for 1.8 weight parts to 4.4 weight parts.

2. The resin composition according to claim 1, wherein
an average particle size of said luminous material is 5 μm.

3. The resin composition according to claim 1, wherein
said resin material containing the copolymer is a styrene based copolymer.

4. The resin composition according to claim 2, wherein
said resin material containing the copolymer is a styrene based copolymer.

5. The resin composition according to claim 3, wherein
said resin material containing the copolymer is an AES resin, an ABS resin, or an ASA resin.

6. The resin composition according to claim 4, wherein
said resin material containing the copolymer is an AES resin, an ABS resin, or an ASA resin.

7. The resin composition according to claim 1, wherein
said luminous material is an aluminum luminous material.

8. The resin composition according to claim 2, wherein
said luminous material is an aluminum luminous material.

9. The resin composition according to claim 3, wherein
said luminous material is an aluminum luminous material.

10. The resin composition according to claim 5, wherein
said luminous material is an aluminum luminous material.

11. The resin composition according to claim 1, wherein
the resin composition is used to generate a resin molded article in silver metallic tone.

12. The resin composition according to claim 2, wherein
the resin composition is used to generate a resin molded article in silver metallic tone.

13. The resin composition according to claim 3, wherein
the resin composition is used to generate a resin molded article in silver metallic tone.

14. The resin composition according to claim 5, wherein
the resin composition is used to generate a resin molded article in silver metallic tone.

15. The resin composition according to claim 7, wherein
the resin composition is used to generate a resin molded article in silver metallic tone.

16. A resin molded article molded from a resin composition, wherein
the resin composition comprises:
a resin material for 100 weight parts containing one or plural kinds of copolymers or containing two or more kinds of substances of which refractive indexes are different; and
a luminous material of which particle size is 1 lam to 7 μm added to the resin material for 1.8 weight parts to 4.4 weight parts.

17. A generation method of a resin composition, comprising:
adding a luminous material of which particle size is 1 μm to 7 μm for 1.8 weight parts to 4.4 weight parts relative to 100 weight parts of a resin material containing one or plural kinds of copolymers or containing two or more kinds of substances of which refractive indexes are different.
